(19) United States
(12) Patent Application Publication
(10) Pub. No.: US 2008/0034383 A1
(43) Pub. Date: Feb. 7, 2008

(54) Damping Mechanisms

(76) Inventors: William Seymour Harwin, Reading (GB); Rui Carlos Vicente Loureiro, Reading (GB)

Correspondence Address: NIXON & VANDERHYE, PC, 901 NORTH GLEBE ROAD, 11TH FLOOR, ARLINGTON, VA, 22203, US

(21) Appl. No.: 11/667,473

(22) PCT Filed: Nov. 11, 2005
(86) PCT No.: PCT/GB05/04341

§ 371 Date: Jun. 14, 2007

(30) Foreign Application Priority Data
Nov. 12, 2004 (GB) 0425072.6

(51) Int. Cl. G11B 33/08

(52) U.S. Cl. 720/651

(57) ABSTRACT

According to the invention there is provided a variable damping mechanism having: at least one shear plate (5a, 5b); a moveable core (8) which has at least one surface which surface opposes the shear plate; a magneto-rheological fluid contained between the shear plate and the moveable core; and an electromagnet (7) which produces a magnetic field whose strength can be varied to change the viscosity of the magneto-rheological fluid; wherein the surface of the core is exposed to the magneto-rheological fluid such that the freedom of movement of the core is dependent upon the viscosity of the magneto-rheological fluid.

The present invention relates to a magneto-rheological variable damping mechanism for use, for example, in damping sensitive equipment or in a haptic interface system for providing a force feedback sensation. In addition, the mechanism can be used as a retrofitted damper, e.g. for a late design change of a system where space is a concern.

There is a problem with operating sensitive equipment in conditions where they are subject to vibrations because the playback of the equipment is not continuous because it is disturbed by the vibrations. Examples of such equipment include a portable magnetic player (e.g. a portable hard disk based player) or optical player (e.g. a portable CD or DVD player) or a magnetic or optical player for use in a vehicle (for example an in-car CD or DVD player). In the usual operation of such players, the player has a mechanism which reads data from a medium placed in the player, for example a CD or DVD or in a hard disk player, the medium is the hard disk itself. Such a player is sensitive to vibrations because in order to read the data from the medium, the mechanism must identify the location of the data on the medium precisely. If the mechanism is jolted whilst it is reading the data, then the data will not be read properly. A variable damping mechanism which has a response rate which is faster than the frequency of the vibrations to which such players are normally subjected would overcome this problem. However known variable damping mechanisms are too bulky for inclusion in such a player.

A haptic interface system provides force feedback to an operator using a computer controlled device. In such systems, variable damping is useful because it can provide an operator with different tactile or kinaesthetic sensations. Thus if an operator is using a computer to create a virtual reality (VR) environment by using a computer controlled interface such as a haptic interface device, a damping mechanism can produce a “feel” which is close to that of reality by resisting user movement where required. For example, if a user has created a computer representation of a 3-dimensional object, they could use a haptic interface to explore the object. In this situation, a haptic interface that provides sufficient information (e.g. stiffness, damping, and position change) can discriminate for physical properties of virtual objects as well as interaction with those objects might be used. When a user who is using the haptic interface utilises it to explore an object in such an environment, the mechanism ideally needs to be able to resist movement of the user's fingers, hand or arm where appropriate, e.g. when contacting a resilient surface. A variable damping mechanism could be used in such a device to provide a suitable response. However known mechanisms that can deliver an acceptable response are too bulky and expensive due to the requirement of stable, precise components where speed and accuracy are important.

A way to ameliorate these problems has been sought.

According to the invention there is provided a variable damping mechanism having:
a shear plate;
a moveable core which has at least one surface which surface opposes the shear plate;
a magneto-rheological fluid contained between the shear plate and the moveable core; and
an electromagnet which produces a magnetic field whose strength can be varied to change the viscosity of the magneto-rheological fluid;
   wherein the surface of the core is exposed to the magneto-rheological fluid such that the core has a freedom of movement which is dependent upon the viscosity of the magneto-rheological fluid.

The advantages of the mechanism include that the exposure of the surface of the core directly to the magneto-rheological (MR) fluid without any intervening material such as a sponge ensures that surface shear and a proper damping effect is obtained dependent on the viscosity of the MR fluid. Thus, two effects are present: shear of fluid between the shear plate and the core when the core is moved, and restriction of fluid flow when viscosity is high. A further advantage of having the surface directly exposed to the MR fluid is that the MR fluid is allowed to flow when the core is moved. This ensures that the MR fluid is mixed by this motion. A problem can arise when the MR fluid is held by an intervening material in that the particles forming the MR fluid tend to separate from its suspension in oil (fluid sedimentation). Additionally, the fluid thickens in use by becoming more viscous and variation of the MR fluid's viscosity by the applied magnetic field is reduced. The present invention overcomes this problem.

The advantages of containing the MR fluid between the shear plate and the surface of the core include that it avoids high static friction normally associated with sealing methods such as piston based systems and also it avoids pressure build up inside the unit when the core is moved. This is because when the core is moved, it does not compress the MR fluid. This is because the direction of movement of the core is substantially parallel to the respective surfaces of the core and the shear plate. This increased pressure would change the responsiveness of a damping mechanism. To avoid this problem, it would normally be necessary to include an accumulator in the mechanism which would add to its bulk and complexity. The present invention avoids this problem.

A further advantage of containing the MR fluid between the shear plate and the surface of the core is that it allows the MR fluid to move when the core is moved, and therefore air bubbles do not form which would reduce the responsiveness of the mechanism.

A further advantage is that the mechanism according to the invention is optionally compact. This is because it optionally has a low profile. This enables the mechanism to be incorporated into small instruments or into a wearable device. This is useful in the treatment of micro clonis (small tremors). Micro clonis is a problem in skilled manipulation tasks such as surgery. The integration of a variable damping mechanism into a wearable device, would allow suppression of such micro clonis.

A further advantage of the optionally low profile variable damping mechanism according to the invention is that it can more easily be added to an existing mechanical system to test damping of the system. Mechanical systems are prone to be sensitive to external vibrations. These generally later on usage. Damping of such vibrations requires positioning of appropriate damping systems which necessitates major design changes. The mechanism according to the invention reduces this problem.

The shear plate and the surface of the core are preferably connected by a flexible web (or bag) such that the shear plate, the surface of the core and the flexible web define a container for the MR fluid. The web is preferably formed from an inert material which is compatible with the MR fluid. Examples of suitable materials include polyurethane, neoprene, nitrile and/or a silicone.

The core and shear plate are preferably formed from a material which can be magnetised such as steel.

The variable damping mechanism according to the invention preferably has at least one drive shaft which connects the core to a moveable surface or object which needs to be damped. The drive shaft is optionally rigid or flexible, for example it can be in the form of a rigid plate, a rigid rod or a flexible plate, depending on the application and the way the device is to be attached to the vibrating medium. The mechanism optionally has one or two drive shafts. Where the mechanism of the invention has two drive shafts, namely a first and a second drive shaft, the first drive shaft could be used to connect the core to a first surface in need of damping whilst the second drive shaft could be used to connect the core to a second surface in need of damping or a position and/or motion sensor. Where both the first and second drive shafts are connected to surfaces in need of damping, the mechanism is preferably adapted to be fixable to a non-moveable surface.

The at least one surface of the core is preferably provided in the form of a channel formed by the surface of the core, the shear plate and at least one spacing member which is provided on the core and/or on the shear plate (preferably the at least one spacing member is provided on the core).

The core is preferably in the form of a plate having an upper and lower shear surface and the mechanism preferably has two shear plates which are substantially parallel to the upper and lower shear surfaces. By having a core with two surfaces, a low profile design is achieved whilst maximising the damping effect and minimising the size of the electromagnet. Minimising the size of the electromagnet has an additional benefit of reducing the power consumption of the mechanism.

To maximise the damping effect of the mechanism, the distance between each shear surface and its corresponding shear plate is preferably minimised. An advantage of using at least one spacing member is that this distance is defined by the spacing member and the spacing member can be used to minimise this distance to reduce the effective shear gap.

The core is preferably moveable in one or two dimensions. Preferably it is moveable in one dimension such that the movement is linear.

The invention is now illustrated with reference to the following Figures of the accompanying drawings which are not intended to limit the scope of the invention claimed of which:

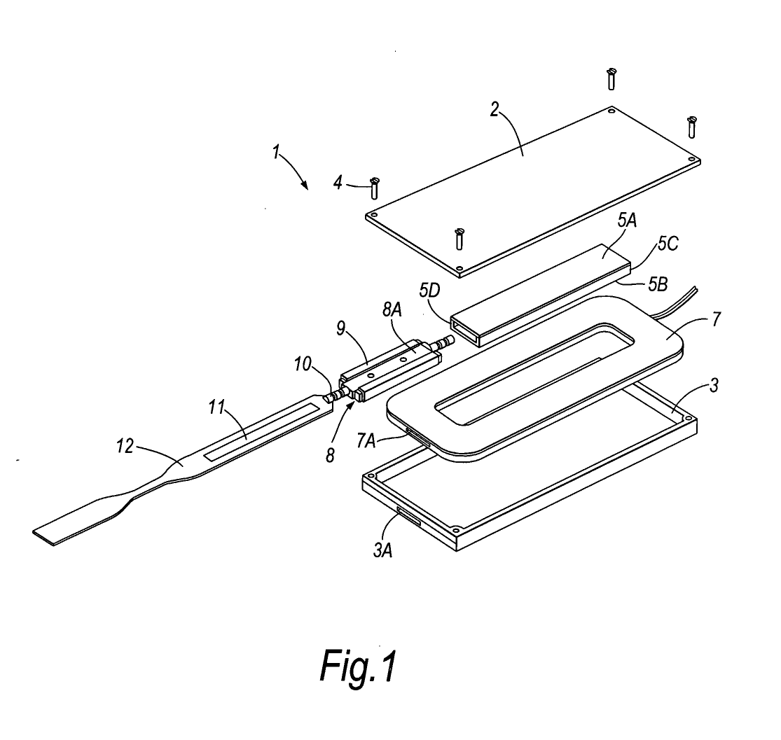

FIG. 1 shows a first embodiment of a variable damping mechanism according to the invention;

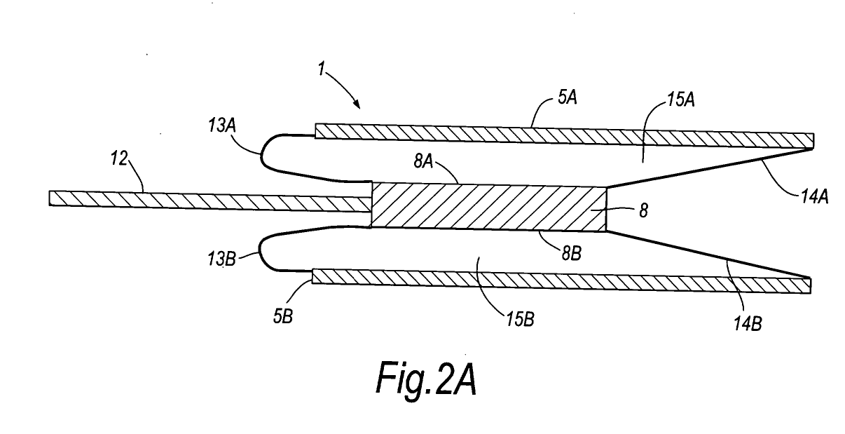

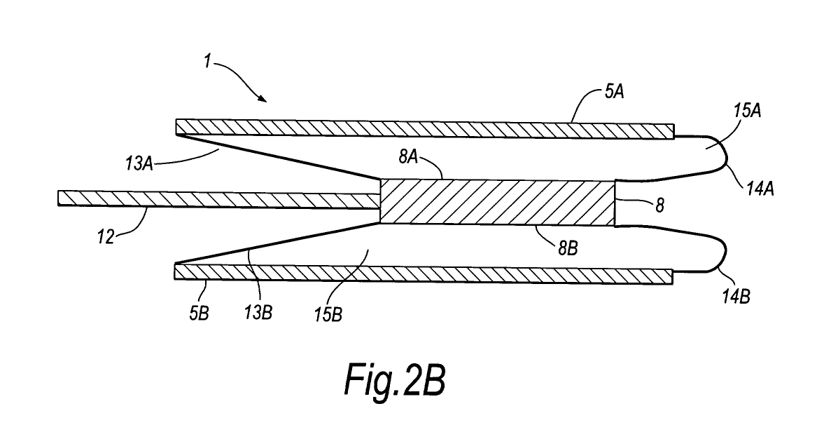

FIG. 2A shows a first cross-sectional view of part of the first embodiment of the variable damping mechanism in an extended position;

FIG. 2B shows a first cross-sectional view of part of the first embodiment of the variable damping mechanism in a retracted position;

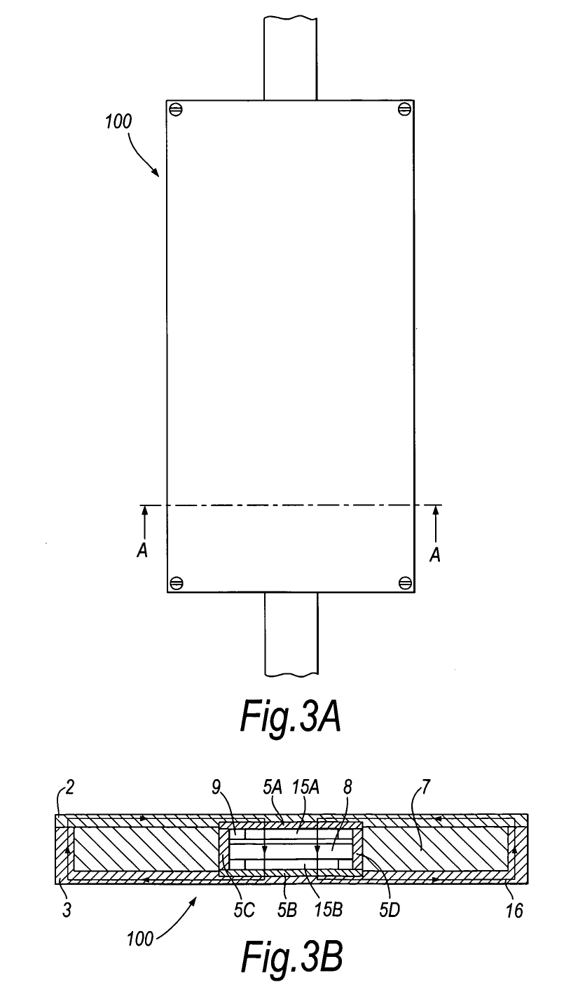

FIG. 3A shows an overhead view of the first embodiment of the variable damping mechanism;

FIG. 3B shows a second cross-sectional view of the first embodiment of the variable damping mechanism taken along a line A-A shown on FIG. 3A;

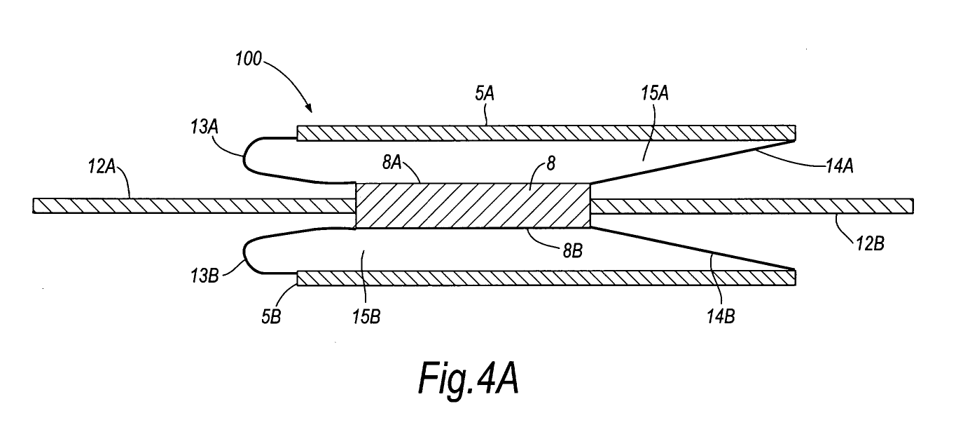

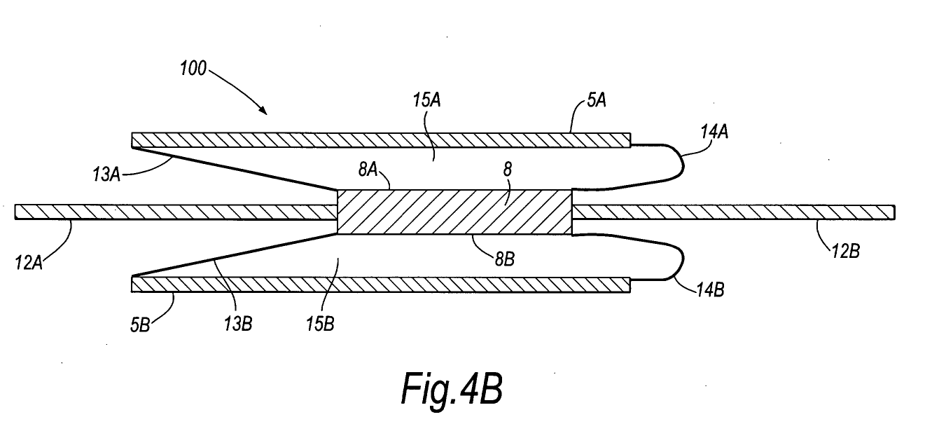

FIG. 4A shows a first cross-sectional view of part of a second embodiment of the variable damping mechanism according to the invention in an extended position;

FIG. 4B shows a first cross-sectional view of part of the second embodiment of the variable damping mechanism in a retracted position;

FIG. 5A shows an overhead view of the second embodiment of the variable damping mechanism; and

FIG. 5B shows a second cross-sectional view of the second embodiment of the variable damping mechanism taken along a line A-A shown on FIG. 5A.

FIGS. 1, 2A, 2B, 3A and 3B show a first embodiment of a variable damping mechanism 1 which has an electromagnet 7 and a pair of shear plates 5A,5B between which is inserted a core indicated generally at 6. The core 8 is formed from a material that can be magnetised, e.g. steel, or MnZn, NiZn ferrite. The shear plates 5A, 5B (which are also formed from a material that can be magnetised, (e.g. steel) are connected to each other by walls 5C, 5D (which are formed from a non-magnetic material, e.g. plastic). The use of non magnetic materials for walls 5C, 5D defines the magnetic circuit (which is shown in FIG. 3B), ensuring the flux lines 16 are directed only to the MR fluid located in chambers 15A, 15B, thus generating perpendicular magnetic flux in relation to the movement of the core 8. The shear plates 5A, 5B are connected to the core 8 by flexible walls 13A, 14A and 13B, 14B to form two chambers 15A, 15B.

In use, a magneto-rheological (MR) fluid (not shown) is provided between the core 8 and the shear plates 5A, 5B. The MR fluid is contained in the two chambers 15A, 15B. Any MR fluid may be used. A MR fluid is generally in the form of fine magnetic particles suspended in an oil solution such as a silicon, vegetable or mineral oil. Commercial examples include a fluid manufactured by LORD Corporation, USA or from Liquids Research LTD, UK.

The core 8 is connected to a drive shaft (which can be in the form of a rigid plate, rod or a flexible plate) 12 by connector 10. The electromagnet 7 and shear plates and walls 5A,5B,5C,5D are supported by a container having a body 3 and a lid 2 fastened together by four fixing means 4 shown in the form of screws. The body 3 and the electromagnet 7 are provided with apertures 3a,7a to allow the drive shaft 12 to connect to an external object which needs to be damped.

The core 8 has dimensions which are a length, width and thickness. Its thickness is small in relation to its other dimensions such that the core has relatively large upper and lower faces. Each of these faces is provided with a pair of spacing members 9 which each run the full length of each face but have a width which is narrower than the width of each face. Thus between each spacing member on each face, there is an exposed surface 8A, 8B of the core. In use this surface 8A, 8B will contact the MR fluid. The spacing members 9 are formed from an inert hard wearing resilient material such as a common engineering polymer plastic, or felt and fabric or a leather material.

The electromagnet 7 is connected to a power supply when the mechanism is in use. The electromagnet 7 is formed from a coil of electrically conductive wire. The magnetic circuit is designed in such way that uses the coil wound in particular way that allows a magnetic field to be produced by the electromagnet 7 which has flux lines perpendicular to the direction of motion of the core 8. This is to maximise shear effect of MR fluid particles and avoid interference of device magnetic fields in any environment in which the mechanism is used.

In use, when the mechanism 1 is linked to the surface of an object (not shown) which requires damping by drive shaft 12. The motion of the object is detected by detection means (not shown) such as a position encoder. A control circuit (not shown) is arranged to receive input from the detection means and then control the current to the electromagnet 7 such that if the detection means detects strong motion of the object, a stronger magnetic field is generated or if the detection means detects weak motion of the electromagnet 7, a weaker magnetic field is generated. The magnetic field generated by the electromagnet 7 changes the viscosity of the MR fluid such that the motion of the core 8 is appropriately damped according to the motion of the surface to which the mechanism is corrected.

This arrangement of the chambers 15A,15B formed in part by the flexible walls 13A,13B,14A,14B allows the device to have reduced friction and avoids the need for an accumulator to allow MR fluid to move when the device is powered to generate high damping forces, thus avoiding high fluid compression by permitting the MR fluid to move with respect to moving core 8 and subsequently ensure MR fluid is present at its surface regardless of the core position. Materials that can be used as the flexible bag should be compatible with the MR fluid and allow long term use. Examples of such materials are polyurethane, neoprene, nitrile and silicone.

FIGS. 4A, 4B, 4A and 4B show a second embodiment of a variable damping mechanism 100 according to the invention. Like features in common between the first and second embodiments are identified by like reference numerals. In the second embodiment, the core 8 has two drive shafts 12A, 12B. Otherwise the second embodiment is substantially the same as the first embodiment.

1. A variable damping mechanism having:
at least one shear plate;
a moveable core which has at least one surface which surface opposes the shear plate;
a magneto-rheological fluid contained between the shear plate and the moveable core; and
an electromagnet which produces a magnetic field whose strength can be varied to change the viscosity of the magneto-rheological fluid;
wherein the surface of the core is exposed to the magneto-rheological fluid such that the freedom of movement of the core is dependent upon the viscosity of the magneto-rheological fluid.

2. A mechanism according to claim 1 wherein the shear plate and the surface of the core are connected by a flexible web to contain the magneto-rheological fluid.

3. A mechanism according to claim 1 wherein the at least one surface of the core is provided in the form of a channel formed by the core, the shear plate and at least one spacing member which is provided on the core and/or on the shear plate.

4. A mechanism according to claim 3 wherein the at least one spacing member is provided on the core.

5. A mechanism according to claim 1 wherein the core is in the form of a plate having an upper and lower shear surface.

6. A mechanism according to claim 1 which has at least one drive shaft suitable for connecting the core to a moveable surface or object which needs to be damped; preferably the mechanism has one or two drive shafts.

7. A mechanism according to claim 1 wherein the distance between the surface of the core and the shear plate is minimised.

8. A mechanism according to claim 1 wherein the core is moveable in one dimension.

9. (canceled)
